(19) United States
(12) Patent Application Publication
(10) Pub. No.: US 2019/0148091 A1
(43) Pub. Date: May 16, 2019

(54) LUMINOUS KEYBOARD

(71) Applicant: Primax Electronics Ltd., Taipei (TW)

(72) Inventors: Chin-Sung Pan, Taipei (TW); Bo-An Chen, Taipei (TW); Ying-Te Chiang, Taipei (TW); Chien-Hung Liu, Taipei (TW); Chen-Hsuan Hsu, Taipei (TW)

(21) Appl. No.: 15/907,885

(22) Filed: Feb. 28, 2018

(30) Foreign Application Priority Data
Nov. 10, 2017 (TW) 106139036

(51) Int. Cl. H01H 13/83; F21V 8/00; H01H 13/7065

(52) U.S. Cl. CPC H01H 13/83; G02B 6/0055; G02B 6/009; H01H 2219/062; H01H 2219/036; H01H 2219/06; H01H 13/7065

(57) ABSTRACT

A luminous keyboard includes at least one key, a switch circuit board, a supporting plate, a backlight module, a reflecting plate and a light-sheltering plate. The backlight module emits a light beam. The backlight module is arranged between the reflecting plate and the light-sheltering plate. A periphery region of the reflecting plate and a periphery region of the light-sheltering plate are thermally laminated or laser welded to define a sealed structure. Since the periphery region of the backlight module is sealed by the sealed structure, the light beam is not leaked out through the periphery region of the backlight module. The space occupied by the sealed structure is not very large. Consequently, the volume of the luminous keyboard is reduced.

### FIELD OF THE INVENTION

The present invention relates to a keyboard, and more particularly to a luminous keyboard with an illuminating function.

### BACKGROUND OF THE INVENTION

Generally, the widely-used peripheral input device of a computer system includes for example a mouse device, a keyboard, a trackball device, or the like. Via the keyboard, characters and symbols can be directly inputted into the computer system. As a consequence, most users and most manufacturers of input devices pay much attention to the development of keyboards.

FIG. 1 is a schematic top view illustrating the outer appearance of a conventional keyboard. As shown in FIG. 1, there are plural keys 10 on a surface of the conventional keyboard 1. These keys 10 are classified into several types, e.g. ordinary keys 101, numeric keys 102 and function keys 103. When one of these keys 10 is depressed by the user's finger, a corresponding signal is issued to the computer, and thus the computer executes a function corresponding to the depressed key. For example, when an ordinary key 101 is depressed, a corresponding English letter or symbol is inputted into the computer. When a numeric key 102 is depressed, a corresponding number is inputted into the computer. In addition, the function keys 103 (F1-F12) can be programmed to provide various functions. For example, the conventional keyboard 1 is a keyboard for a notebook computer.

With the maturity of the computing technologies, the keyboard manufacturers make efforts in designing novel keyboards with special functions in order to meet diversified requirements of different users. For this reason, luminous keyboards are favored by users. The outer appearance of the conventional luminous keyboard is substantially similar to the outer appearance of the conventional keyboard 1. Since the luminous keyboard provides the function of illuminating the keys, the inner structure of the luminous keyboard is different from the inner structure of the keyboard without the illuminating function. Hereinafter, the inner structure of the luminous keyboard will be illustrated in more details. FIG. 2 is a schematic cross-sectional view illustrating a conventional luminous keyboard. As shown in FIG. 2, the conventional luminous keyboard 2 comprises plural keys 20, a membrane switch circuit board 21, a supporting plate 22 and a backlight module 23. Each key 20 comprises a keycap 201, a scissors-type connecting element 202 and an elastic element 203. In the key 20, the keycap 201 is exposed outside the conventional luminous keyboard 2, so that the keycap 201 can be depressed by the user. The scissors-type connecting element 202 is used for connecting the keycap 201 and the supporting plate 22. The elastic element 203 is penetrated through the scissors-type connecting element 202. In addition, both ends of the elastic element 203 are contacted with the keycap 201 and the membrane switch circuit board 21, respectively. The supporting plate 22 is located under the membrane switch circuit board 21. The keycap 201, the scissors-type connecting element 202, the elastic element 203 and the membrane switch circuit board 21 are supported on the supporting plate 22.

The membrane switch circuit board 21 comprises an upper wiring board 211, a separation layer 212, and a lower wiring board 213. The upper wiring board 211, the separation layer 212 and the lower wiring board 213 are all made of a light-transmissible material. The light-transmissible material is for example polycarbonate (PC) or polyethylene (PE). The upper wiring board 211 has plural upper contacts 2111. The separation layer 212 is located under the upper wiring board 211, and comprises plural perforations 2121 corresponding to the plural upper contacts 2111. The lower wiring board 213 is located under the separation layer 212, and comprises plural lower contacts 2131 corresponding to the plural upper contacts 2111. The plural lower contacts 2131 and the plural upper contacts 2111 are collectively defined as plural key switches 214.

The backlight module 23 comprises a light guide plate 230, a circuit board 231, plural light-emitting elements 232, a reflecting plate 233 and a light-sheltering plate 234. For clarification and brevity, only two light-emitting elements 232 are shown in the drawing. The light guide plate 230 is located under the supporting plate 22. The circuit board 231 is located under the membrane switch circuit board 21 and electrically connected with the light-emitting elements 232. The circuit board 231 provides electric power to the plural light-emitting elements 232. The plural light-emitting elements 232 are disposed on the circuit board 231. In addition, the plural light-emitting elements 232 are inserted into plural reflecting plate openings 2331 of the reflecting plate 233 and plural light guide plate openings 2301 of the light guide plate 230, respectively. By acquiring the electric power, the plural light-emitting elements 232 are driven to emit plural light beams B. Moreover, the plural light beams B are introduced into the light guide plate 230. After portions of the light beams B are exited from the light guide plate 230, the light beams B are reflected back into the light guide plate 320 by the reflecting plate 233. The light-sheltering plate 234 is located over the light guide plate 230 for sheltering the light beams B. For example, the plural light-emitting elements 232 are side-view light emitting diodes. After the light beams B are introduced into the light guide plate 230, the light beams B are subjected to total internal reflection within the light guide plate 230. Then, the light beams B are guided to the keycap 201 by the light guide plate 230.

From top to bottom, the keycap 201, the scissors-type connecting element 202, the elastic element 203, the membrane switch circuit board 21, the supporting plate 22, the light-sheltering plate 234, the light guide plate 230 and the reflecting plate 233 of the conventional luminous keyboard 2 are sequentially shown. For example, the conventional luminous keyboard 2 is a keyboard for a notebook computer (not shown).

In the conventional luminous keyboard 2, each keycap 201 has a light-outputting zone 2011. The light-outputting zone 2011 is located at a character region or a symbol region of the keycap 201. Moreover, the position of the light-outputting zone 2011 is aligned with the position of a corresponding light-guiding dot 2302 of the light guide plate 230. The light beams can be guided upwardly to the light-outputting zone 2011 by the corresponding light-guiding dot 2302. The light-sheltering plate 234 comprises plural light-sheltering plate openings 2341. The plural light-sheltering plate openings 2341 are aligned with the corresponding light-guiding dots 2302 and the corresponding light-outputting zones 2011. Consequently, the light beams B are transmitted through the light-sheltering plate openings 2341 of the light-sheltering plate 234. Similarly, the supporting plate 22 comprises plural supporting plate openings 221. The plural supporting plate openings 221 are aligned with the corresponding light-guiding dots 2302 and the corresponding light-outputting zones 2011. Consequently, the light beams B are transmitted through the supporting plate openings 221 of the supporting plate 22.

On the other hand, since the membrane switch circuit board 21 is made of the light-transmissible material, the plural light beams B can be transmitted through the membrane switch circuit board 21. Consequently, after the plural light beams B are guided by the light-guiding dots 2302, the plural light beams B are sequentially transmitted through the plural supporting plate openings 221 and the membrane switch circuit board 21 and directed to the plural light-outputting zones 2011, thereby illuminating the character region or the symbol region of the keycap 201. Under this circumstance, the illuminating function is achieved.

Please refer to FIG. 2 again. For sealing the light guide plate 230, the lateral edges 2332 of the reflecting plate 233 have to be attached on the light-sheltering plate 234. Consequently, the light beams B are not leaked from the lateral edges of the light guide plate 230. That is, the problem of causing light leakage will be eliminated. Since the lateral edge 2332 of the reflecting plate 233 is attached on the light-sheltering plate 234, the attaching structure between the lateral edges 2332 of the reflecting plate 233 and the light-sheltering plate 234 occupies a space, it is difficult to reduce the volume of the luminous keyboard.

Therefore, there is a need of providing a luminous keyboard with reduced volume and capable of solving the lateral light leakage problem.

### SUMMARY OF THE INVENTION

An object of the present invention provides a luminous keyboard with reduced volume and capable of solving the lateral light leakage problem.

In accordance with an aspect of the present invention, there is provided a luminous keyboard. The luminous keyboard includes at least one key, a switch circuit board, a supporting plate, a backlight module, a reflecting plate and a light-sheltering plate. The at least one key is exposed outside the luminous keyboard. The switch circuit board is located under the at least one key. When the switch circuit board is triggered by the at least one key, a corresponding key signal is generated. The supporting plate is located under the switch circuit board and connected with the at least one key. The backlight module is located under the supporting plate. Moreover, the backlight module generates a light beam and projects the light beam to the at least one key. The reflecting plate is disposed within the backlight module. The light beam is reflected by the reflecting plate. The light-sheltering plate is arranged between the backlight plate and the supporting plate to shield the light beam. A periphery region of the reflecting plate and a periphery region of the light-sheltering plate are thermally laminated or laser welded to define a sealed structure. Consequently, the light beam is not leaked out through a periphery region of the backlight module.

From the above descriptions, the present invention provides the luminous keyboard. The periphery region of the reflecting plate and the periphery region of the light-sheltering plate are extended over the backlight module. Moreover, the periphery region of the reflecting plate and the periphery region of the light-sheltering plate are thermally laminated or laser welded to form the sealed structure. Consequently, the light beams are not leaked out through the lateral edge of the backlight module. In other words, the lateral light leakage problem can be avoided. When compared with the attaching structure of the conventional technology, the sealed structure formed through the thermally laminating process or the laser welding process does not occupy much space. Under this circumstance, the available space within the luminous keyboard is increased, and the volume of the luminous keyboard can be further reduced.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic top view illustrating the outer appearance of a conventional keyboard;

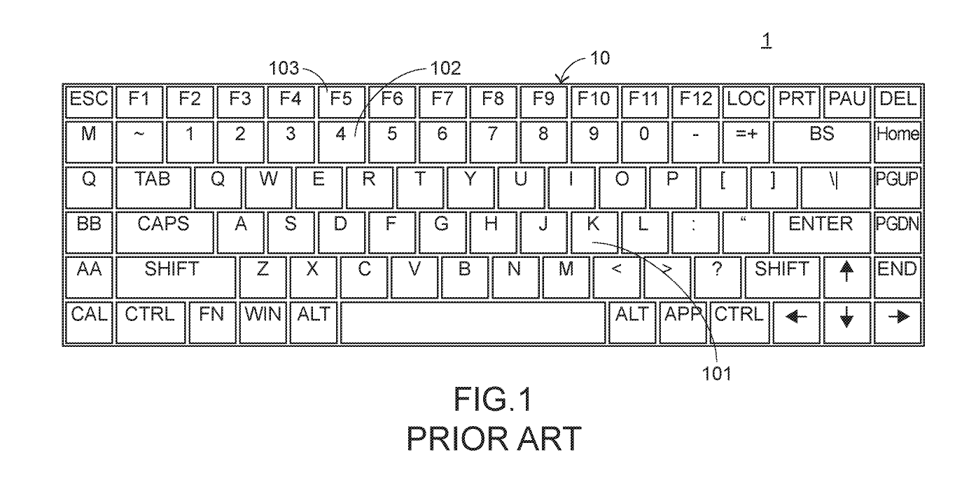

FIG. 2 is a schematic cross-sectional view illustrating a conventional luminous keyboard;

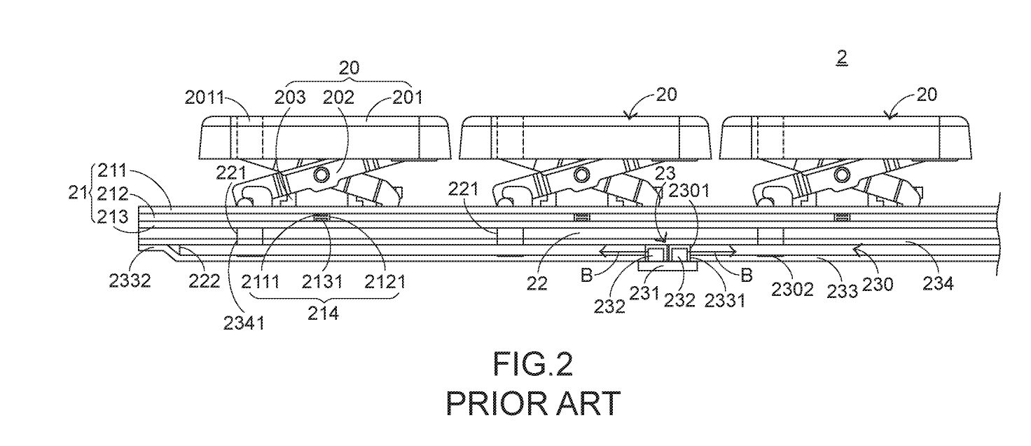

FIG. 3 is a schematic exploded view illustrating a portion of a luminous keyboard according to an embodiment of the present invention; and

FIG. 4 is a schematic cross-sectional view illustrating a portion of the luminous keyboard according to the embodiment of the present invention.

### DETAILED DESCRIPTION OF THE PREFERRED EMBODIMENT

For overcoming the drawbacks of the conventional technology, the present invention provides a luminous keyboard.

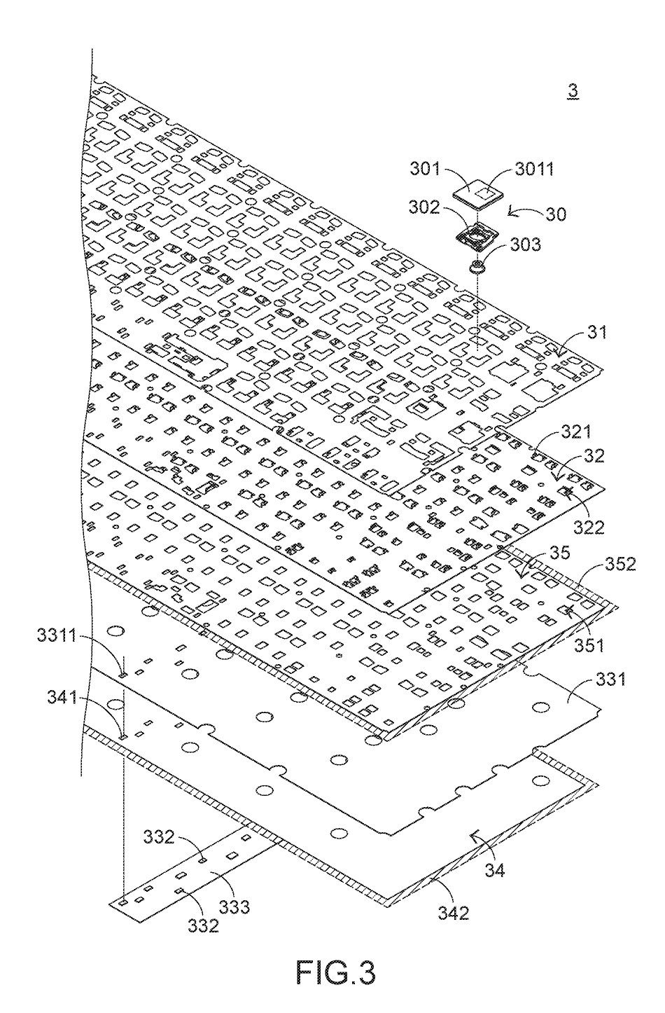

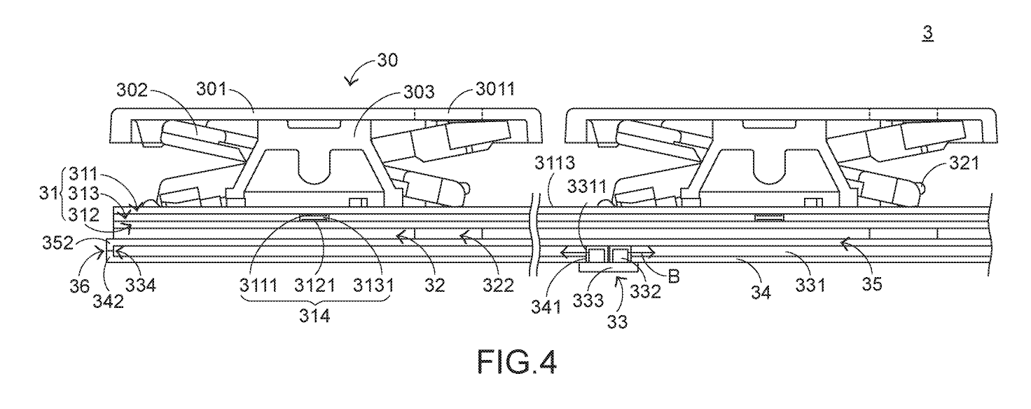

The structure of the luminous keyboard will be described with reference to FIGS. 3 and 4. FIG. 3 is a schematic exploded view illustrating a portion of a luminous keyboard according to an embodiment of the present invention. FIG. 4 is a schematic cross-sectional view illustrating a portion of the luminous keyboard according to the embodiment of the present invention. The luminous keyboard 3 comprises plural keys 30, a switch circuit board 31, a supporting plate 32, a backlight module 33, a reflecting plate 34 and a light-sheltering plate 35. The plural keys 30 are exposed outside the luminous keyboard 3. The switch circuit board 31 is located under the plural keys 30. When the switch circuit board 31 is triggered by one of the plural keys 30, a corresponding key signal is generated. The supporting plate 32 is located under the switch circuit board 31 and connected with the plural keys 30. The supporting plate 32 comprises plural hooks 321 and plural supporting plate openings 322. The backlight module 33 is located under the supporting plate 32. The backlight module 33 is used for emitting light beams B and projecting the light beams B to the plural keys 30. The reflecting plate 34 is disposed within the backlight module 33 for reflecting the light beams B. The light-sheltering plate 35 is arranged between the backlight module 33 and the supporting plate 32 for sheltering the light beams B.

As shown in FIGS. 3 and 4, each key 30 comprises a keycap 301, a connecting element 302 and an elastic element 303. Each keycap 301 has a light-outputting zone 3011. After the light beams B pass through the light-outputting zone 3011, the key 31 is illuminated. The keycap 301 is exposed outside the luminous keyboard 3, and thus the keycap 301 can be depressed by the user. The connecting element 302 is used for connecting the keycap 301 and the hooks 321 of the supporting plate 32. Consequently, the keycap 301 is moved upwardly or downwardly relative to the supporting plate 32. The elastic element 303 is penetrated through the connecting element 302. In addition, both ends of the elastic element 303 are contacted with the keycap 301 and the switch circuit board 31, respectively. As the keycap 301 is moved downwardly to push the elastic element 303, the switch circuit board 31 is pressed by the elastic element 303.

In this embodiment, the connecting element 302 is a scissors-type connecting element, and the elastic element 303 is a rubbery elastomer. Preferably but are not exclusively, the plural keycaps 301 of the plural keys are moved upwardly or downwardly with the connecting elements 302, and the switch circuit board 31 is depressed by the elastic elements 303 through the connecting elements 302. In another embodiment, the connecting elements are non-scissors connecting elements for controlling movements of the keys. For example, a crater-shaped connecting element for a desktop computer is one of the non-scissors connecting elements. In a further embodiment, the keycaps are moved upwardly or downwardly in response to magnetic forces.

The structure of the switch circuit board 31 will be described as follows. The switch circuit board 31 comprises an upper wiring plate 311, a lower wiring plate 312 and a separation layer 313. The upper wiring plate 311 is contacted with the elastic elements 303 of the keys 30. The upper wiring board 311 has plural upper contacts 3111. The lower wiring plate 312 is located under the upper wiring plate 311. The lower wiring plate 312 comprises plural lower contacts 3121 corresponding to the plural upper contacts 3111. The separation layer 313 is arranged between the upper wiring plate 311 and the lower wiring plate 312. When the key 30 is not depressed, the upper wiring plate 311 and the lower wiring plate 312 are separated from each other by the separation layer 313. Consequently, the upper contact 3111 and the corresponding low contact 3121 are not erroneously contacted. The separation layer 313 comprises plural perforations 3131 corresponding to the plural upper contacts 3111. The plural upper contacts 3111, the plural lower contacts 3121 and the plural perforations 3131 are collectively defined as plural key switches 314. When the switch circuit board 31 is pressed by the elastic element 303, the corresponding upper contact 3111 is inserted into the corresponding perforation 3131 and contacted with the corresponding lower contact 3121. Consequently, the corresponding key signal is generated. In an embodiment, the switch circuit board 31 is a membrane switch circuit board. Moreover, the upper wiring plate 311, the lower wiring plate 312 and the separation layer 313 are made of a light-transmissible material for allowing the light beams B to go through.

The structure of the backlight module 33 will be described as follows. The backlight module 33 comprises a light guide plate 331, plural light-emitting elements 332 and a circuit board 333. The light guide plate 331 is arranged between the light-sheltering plate 35 and the reflecting plate 34. The light guide plate 331 is used for guiding the light beams B to the light-outputting zones 3011. The light guide plate 331 comprises plural light guide plate openings 3311 and plural light-guiding parts (not shown). Each light guide plate opening 3311 is aligned with one of the plural light-emitting elements 332. The light-guiding parts are used for guiding the light beams B to be exited from the light guide plate 331 and projected to the light-outputting zones 3011. The light-emitting elements 332 are used for generating the light beams B. The plural light-emitting elements 332 are supported on the circuit board 334. The circuit board 334 is located under the reflecting plate 34 and electrically connected with the light-emitting elements 332. The circuit board 334 provides electric power to the plural light-emitting elements 332. By acquiring the electric power, the plural light-emitting elements 332 are driven to emit the light beams B. In this embodiment, the light-emitting element 332 is a side-view light emitting diode, the light-guiding part is one of a light-guiding microstructure, a light-guiding dot, a light-guiding ink and a light-guiding texturing structure, and the circuit board 334 is a flexible printed circuit (FPC).

The reflecting plate 34 is arranged between the light guide plate 331 and the circuit board 333. The reflecting plate 34 comprises plural reflecting plate openings 341. The reflecting plate openings 341 are aligned with the corresponding light guide plate openings 3311. The light-emitting elements 332 are inserted into the corresponding reflecting plate openings 341 and the corresponding light guide plate openings 3311. Consequently, the light beams B from the light-emitting elements 332 are introduced into the light guide plate 331. The light-sheltering plate 35 is arranged between the supporting plate 32 and the light guide plate 331. The light-sheltering plate 35 comprises plural light-sheltering plate openings 351. The plural light-sheltering plate openings 351 are aligned with the corresponding to the supporting plate openings 322. Consequently, the light beams B are transmitted through the light-sheltering plate openings 351 and the supporting plate openings 322, and projected to the corresponding light-outputting zones 3011 of the keycaps 301.

When the light-emitting elements 332 are driven to emit the light beams B, the light beams B are introduced into the light guide plate 331. The light beams B are guided by the light-guiding parts and exited from the light guide plate 331. Then, the light beams B are transmitted through the light-sheltering plate openings 351, the supporting plate openings 322 and the switch circuit board 31, and projected to the corresponding light-outputting zones 3011 of the keycaps 301. Moreover, portions of the light beams B are exited from the light guide plate 331 but not guided by the light-guiding parts. The portions of the light beams B that are exited from the light guide plate 331 are reflected back into the light guide plate 331 by the reflecting plate 34 and further guided to the light-outputting zones 3011 by the light-guiding parts.

For solving the solving the lateral light leakage problem, the luminous keyboard 3 of the present invention is specially designed. For example, at least one periphery region 342 of the reflecting plate 34 (i.e., the region circumscribed by dotted lines as shown in FIG. 3) and at least one periphery region 352 of the light-sheltering plate 35 are thermally laminated or laser welded. Consequently, the reflecting plate 34 and the light-sheltering plate 35 are combined together, and at least one periphery region 334 of the backlight module 33 is covered by the reflecting plate 34 and the light-sheltering plate 35. After the thermally laminating process or the laser welding process is completed, a sealed structure 36 is defined by the periphery region 342 of the reflecting plate 34 and the periphery region 352 of the light-sheltering plate 35. Consequently, the light beams B are not leaked out through the at least one periphery region 334 of the backlight module 33. The sealed structure 36 is shown in FIG. 4.

The operations of depressing the keycap 301 of the luminous keyboard 3 will be described as follows. Please refer to FIG. 3 again. While one of the keycaps 301 is depressed by the user's finger, the keycap 301 is moved downwardly in response to the external force. Since the connecting element 302 is pushed by the keycap 301, the connecting element 302 is correspondingly swung relative to the supporting plate 32. Moreover, as the keycap 301 is moved downwardly to push the elastic element 303, the elastic element 303 is subjected to deformation to trigger the corresponding key switch 314 of the switch circuit board 31. Consequently, the switch circuit board 31 generates a corresponding key signal. When the keycap 301 is no longer depressed by the user and no external force is exerted on the keycap 301, the elastic element 303 is not pushed by the keycap 301. Meanwhile, the elastic element 303 is restored to its original shape from the deformed state in response to the elasticity of the elastic element 303. In addition, the elastic element 303 provides an upward restoring force to the keycap 301. As the keycap 301 is moved upwardly, the connecting element 302 is correspondingly swung. Consequently, the keycap 301 is returned to its original position.

The following two aspects should be specially described. Firstly, the number of the at least one sealed structure 36 of the luminous keyboard 3 is not restricted. In case that one sealed structure is formed by thermally laminating or laser welding one periphery region 342 of the reflecting plate 34 and one periphery region 352 of the light-sheltering plate 35, the other three periphery regions 342 of the reflecting plate 34 and the other three periphery regions 352 of the light-sheltering plate 35 are connected with each other by using the conventional attaching process. Since one attaching structure is saved, the volume of the luminous keyboard 3 is reduced. In a preferred embodiment, four periphery regions 342 of the reflecting plate 34 and four periphery regions 352 of the light-sheltering plate 35 are thermally laminated or laser welded to define four sealed structure 36. Consequently, the volume of the luminous keyboard 3 is further reduced.

Secondly, a process of assembling the luminous keyboard 3 will be described as follows. After a specified periphery region 342 of the reflecting plate 34 and the corresponding periphery region 352 of the light-sheltering plate 35 are thermally laminated or laser welded, a sealed structure 36 is formed. Then, the light guide plate 331, the plural light-emitting elements 332 and the circuit board 333 are arranged beside the sealed structure 36. Then, the other three periphery regions 342 of the reflecting plate 34 and the other three periphery regions 352 of the light-sheltering plate 35 are sealed. Consequently, the backlight module 33 is completely sealed between the reflecting plate 34 and the light-sheltering plate 35. Then, the combination of the light-sheltering plate 35, the backlight module 33 and the reflecting plate 34 is assembled with the plural keys 30, a switch circuit board 31 and the supporting plate 32.

From the above descriptions, the present invention provides the luminous keyboard. The periphery region of the reflecting plate and the periphery region of the light-sheltering plate are extended over the backlight module. Moreover, the periphery region of the reflecting plate and the periphery region of the light-sheltering plate are thermally laminated or laser welded to form the sealed structure. Consequently, the light beams are not leaked out through the lateral edge of the backlight module. In other words, the lateral light leakage problem can be avoided. When compared with the attaching structure of the conventional technology, the sealed structure formed through the thermally laminating process or the laser welding process does not occupy much space. Under this circumstance, the available space within the luminous keyboard is increased, and the volume of the luminous keyboard can be further reduced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all modifications and similar structures.

What is claimed is:

1. A luminous keyboard, comprising:
at least one key exposed outside the luminous keyboard;
a switch circuit board located under the at least one key, wherein when the switch circuit board is triggered by the at least one key, a corresponding key signal is generated;
a supporting plate located under the switch circuit board and connected with the at least one key;
a backlight module located under the supporting plate, and generating a light beam and projecting the light beam to the at least one key;
a reflecting plate disposed within the backlight module, wherein the light beam is reflected by the reflecting plate; and
a light-sheltering plate arranged between the backlight plate and the supporting plate to shield the light beam, wherein a periphery region of the reflecting plate and a periphery region of the light-sheltering plate are thermally laminated or laser welded to define a sealed structure, so that the light beam is not leaked out through a periphery region of the backlight module.

2. The luminous keyboard according to claim 1, wherein the backlight module comprises:
a light guide plate arrange between the light-sheltering plate and the reflecting plate to guide the light beam to the at least one key, wherein the light guide plate comprises a light guide plate opening;
a light-emitting element inserted into the light guide plate opening, and emitting the light beam; and
a circuit board located under the reflecting plate and electrically connected with the light-emitting element, wherein the light-emitting element is supported on the circuit board.

3. The luminous keyboard according to claim 2, wherein the reflecting plate is arranged between the light guide plate and the circuit board, and the reflecting plate comprises a reflecting plate opening corresponding to the light guide plate opening, wherein the light-emitting element is inserted into the reflecting plate opening and the light guide plate opening.

4. The luminous keyboard according to claim 1, wherein the at least one key comprises:
a keycap exposed outside the luminous keyboard, wherein the keycap comprises at least one light-outputting zone, and the light beam is transmitted through the at least one light-outputting zone;
a connecting element arranged between the supporting plate and the keycap, wherein the supporting plate and the keycap are connected with each other through the connecting element, so that the keycap is movable upwardly or downwardly relative to the supporting plate; and
an elastic element arranged between the keycap and the switch circuit board, wherein while the keycap is depressed to push the elastic element, the switch circuit board is pressed by the elastic element.

5. The luminous keyboard according to claim 4, wherein while the keycap is depressed, the connecting element is correspondingly swung and the elastic element is pushed by the keycap, so that the elastic element is subjected to deformation to press the switch circuit board, wherein when the keycap is not depressed, the elastic element is restored to an original shape and provides an elastic force to the keycap, so that the keycap is returned to an original position.

6. The luminous keyboard according to claim 4, wherein the supporting plate comprises at least one supporting plate opening corresponding to the at least one light-outputting zone, and the light beam is transmitted through the supporting plate opening and projected to the light-outputting zone.

7. The luminous keyboard according to claim 6, wherein the light-sheltering plate is arranged between the supporting plate and the light guide plate, and the light-sheltering plate comprises at least one light-sheltering plate opening, wherein the light beam is transmitted through the light-sheltering plate opening and the supporting plate opening, and projected to the light-outputting zone.

8. The luminous keyboard according to claim 4, wherein the switch circuit board comprises:
an upper wiring board contacted with the elastic element, wherein the upper wiring board comprises an upper conductive part;
a lower wiring board located under the upper wiring board, wherein the lower wiring board comprises a lower conductive part; and
a separation layer arranged between the upper wiring board and the lower wiring board, wherein the upper conductive part and the lower conductive part are separated from each other by the separation layer, and the separation layer comprises a separation layer opening,
wherein when the upper wiring board is triggered by the elastic element, the upper conductive part is penetrated through the separation layer opening and contacted with the lower conductive part, so that the switch circuit board generates the key signal.

9. The luminous keyboard according to claim 8, wherein the upper wiring board, the lower wiring board and the separation layer are made of light-transmissible material, so that the light beam is transmissible through the upper wiring board, the lower wiring board and the separation layer.
